(19) United States
(12) Patent Application Publication
(10) Pub. No.: US 2017/0044461 A1
(43) Pub. Date: Feb. 16, 2017

(54) Refrigerating-machine oil and working-fluid composition for refrigerating machine

(71) Applicant: JX Nippon Oil & Energy Corporation, Tokyo (JP)

(72) Inventors: Hitoshi Takahashi, Tokyo (JP); Tsutomu Takahashi, Tokyo (JP); Souichirou Konno, Tokyo (JP)

(73) Assignee: JX Nippon Oil & Energy Corporation, Tokyo (JP)

(21) Appl. No.: 15/304,775

(22) PCT Filed: Mar. 23, 2015
(86) PCT No.: PCT/JP2015/058757

§ 371 Date: Oct. 17, 2016

(30) Foreign Application Priority Data
Apr. 23, 2014 (JP) 2014-089617

(51) Int. Cl. C10M 171/00; C09K 5/04; C10M 105/24; C10M 105/14; C10M 169/04

(52) U.S. Cl. CPC C10M 171/008; C10M 105/14; C10M 169/04; C10M 105/24; C09K 5/044; C10M 2207/0225; C10M 2207/122; C10M 2207/126; C10N 2240/30; C09K 2205/126

(57) ABSTRACT

The invention provides a refrigerating machine oil comprising, as a base oil, at least one oxygen-containing oil having a carbon/oxygen molar ratio of 2.5 or more and 5.8 or less, and the refrigerating machine oil being used with a 1-chloro-3,3,3-trifluoropropene refrigerant.

### TECHNICAL FIELD

The present invention relates to a refrigerating machine oil, and a working fluid composition for a refrigerating machine; use of a composition containing at least one oxygen-containing oil as a base oil for a refrigerating machine oil or a working fluid composition for a refrigerating machine; and use of a composition containing at least one oxygen-containing oil as a base oil for manufacturing a refrigerating machine oil or a working fluid composition for a refrigerating machine.

### BACKGROUND ART

CFC (chlorofluorocarbon) and HCFC (hydrochlorofluoro-carbon), which have been heretofore used as a refrigerant for refrigerating equipment, are now subject to regulation from the recent fear of ozone layer destruction, and alternatively HFC (hydrofluorocarbon) has come to be used as a refrigerant. However, among HFC refrigerants, HFC-134a, which has been used for a car air-conditioner refrigerant like a standard material, is also subject to regulation in Europe, because its global warming potential (GWP) is high, despite its zero ozone depletion potential (ODP).

Under such circumstances, there is an urgent need to develop a refrigerant that has little influence on the ozone layer and exhibits low GWP. For example, Patent Literature 1 discloses a trans-1-chloro-3,3,3-trifluoropropene (1233zd(E)) refrigerant as a refrigerant having low ODP and GWP.

In the case of a conventional refrigerant such as CFC and HCFC, a refrigerating machine oil containing a hydrocarbon oil, such as a mineral oil and an alkylbenzene, has been used favorably, however, since a refrigerating machine oil may exhibit, depending on the kind of a coexisting refrigerant, an unexpected behavior in terms of compatibility with a refrigerant, lubricity, viscosity of a solution with a refrigerant, and thermal and chemical stability, development of a refrigerating machine oil for each refrigerant becomes necessary.

### CITATION LIST

### Patent Literature

Patent Literature 1: International Publication No. WO 2010/077898

### SUMMARY OF INVENTION

### Technical Problem

An object of the present invention is to provide a refrigerating machine oil superior in suitability with a 1-chloro-3,3,3-trifluoropropene (1233zd) refrigerant, and a working fluid composition for a refrigerating machine containing the refrigerating machine oil.

### Solution to Problem

The present invention provides a refrigerating machine oil comprising as a base oil at least one oxygen-containing oil having a carbon/oxygen molar ratio of 2.5 or more and 5.8 or less, and being used with a 1-chloro-3,3,3-trifluoropropene refrigerant.

The present invention provides a working fluid composition for a refrigerating machine comprising a refrigerating machine oil containing as a base oil at least one oxygen-containing oil having a carbon/oxygen molar ratio of 2.5 or more and 5.8 or less, and a 1-chloro-3,3,3-trifluoropropene refrigerant.

It is preferable that the refrigerating machine oil contain, as the oxygen-containing oil, an ester of a fatty acid and a polyhydric alcohol, wherein a ratio of C4 to C20 fatty acids in the fatty acid is from 20 to 100% by mole.

It is preferable that the 1-chloro-3,3,3-trifluoropropene refrigerant be a trans-1-chloro-3,3,3-trifluoroprop ene refrigerant.

It may also be deemed that the present invention is a use of a composition containing as a base oil at least one oxygen-containing oil having a carbon/oxygen molar ratio of 2.5 or more and 5.8 or less for a refrigerating machine oil being used with a 1-chloro-3,3,3-trifluoropropene refrigerant, or a working fluid composition for a refrigerating machine containing a refrigerating machine oil and a 1-chloro-3,3,3-trifluoropropene refrigerant.

Further, it may also be deemed that the present invention is a use of an oxygen-containing oil having a carbon/oxygen molar ratio of 2.5 or more and 5.8 or less for manufacturing a refrigerating machine oil being used with a 1-chloro-3,3,3-trifluoropropene refrigerant, or a working fluid composition for a refrigerating machine containing a refrigerating machine oil and a 1-chloro-3,3,3-trifluoropropene refrigerant.

### Advantageous Effects of Invention

According to the present invention, a refrigerating machine oil superior in suitability with a 1-chloro-3,3,3-trifluoropropene (1233zd) refrigerant, and a working fluid composition for a refrigerating machine containing the refrigerating machine oil can be provided.

### DESCRIPTION OF EMBODIMENTS

Preferred embodiments of the present invention will be described below in detail.

A refrigerating machine oil according to the present embodiment comprises as a base oil at least one oxygen-containing oil having a carbon/oxygen molar ratio of 2.5 or more and 5.8 or less, and is used with a 1-chloro-3,3,3-trifluoropropene refrigerant.

A working fluid composition for a refrigerating machine according to the present embodiment comprises a refrigerating machine oil containing as a base oil at least one oxygen-containing oil having a carbon/oxygen molar ratio of 2.5 or more and 5.8 or less, and a 1-chloro-3,3,3-trifluoropropene refrigerant. In this regard, a working fluid composition for a refrigerating machine according to the present embodiment includes an embodiement, which contains a refrigerating machine oil according to the present embodiment and a 1-chloro-3,3,3-trifluoropropene refrigerant.

A base oil is at least one oxygen-containing oil, in which the carbon/oxygen molar ratio is from 2.5 or more and 5.8 or less. The carbon/oxygen molar ratio of such an oxygen-containing oil is preferably 3.2 or more, and more preferably 4.0 or more from the viewpoints of compatibility with a refrigerant and stability, and preferably 5.0 or less. A carbon/oxygen molar ratio can be analyzed quantitatively by a commonly used element analysis method. Examples of an analysis method of carbon include methods of a thermal conductivity method or a gas chromatography method after conversion to carbon dioxide by burning. As an analysis method of oxygen, a carbonic reduction method is commonly used, by which the oxygen is converted using carbon to carbon monoxide and then analyzed quantitatively, and the Shutze-Unterzaucher method has been broadly put into practical use.

Examples of an oxygen-containing oil include an ester, polyvinyl ether, polyalkylene glycol, a carbonate, a ketone, polyphenyl ether, silicone, polysiloxane, and perfluoroether; and an ester, polyvinyl ether, and polyalkylene glycol are preferable, and an ester is more preferable.

Examples of an ester include an aromatic ester, a dibasic ester, a polyolester, a complex ester, a carbonic ester, and a mixture thereof; and a polyolester is preferable.

As an aromatic ester, an ester of an aromatic mono to hexa-carboxylic, preferably mono to tetra-carboxylic, more preferably mono to tri-carboxylic acid, and a C1 to C18, preferably C1 to C12 aliphatic alcohol, or the like is used. Specific examples of an aromatic mono to hexa-carboxylic acid include benzoic acid, phthalic acid, isophthalic acid, terephthalic acid, trimellitic acid, pyromellitic acid, and a mixture thereof. Specific examples of a C1 to C18 aliphatic alcohol include methanol, ethanol, propanol, butanol, pentanol, hexanol, heptanol, octanol, nonanol, decanol, undecanol, dodecanol, tridecanol, tetradecanol, pentadecanol, hexadecanol, heptadecanol, octadecanol, and a mixture thereof. The C1 to C18 aliphatic alcohol may be linear or branched. With respect to an aromatic dicarboxylic or higher carboxylic acid, a simple ester constituted with an alcohol consisting of one aliphatic alcohol may be used, or a complex ester constituted with alcohols consisting of two or more aliphatic alcohols may be also used.

As a dibasic ester, esters of a C5 to C10 dibasic acid, such as glutaric acid, adipic acid, pimelic acid, suberic acid, azelaic acid, and sebacic acid, and a C1 to C15 monohydric alcohol having a linear or branched alkyl group, such as methanol, ethanol, propanol, butanol, pentanol, hexanol, heptanol, octanol, nonanol, decanol, undecanol, dodecanol, tridecanol, tetradecanol, and pentadecanol, as well as a mixture thereof may be used preferably.

A polyolester is an ester synthesized from a polyhydric alcohol and a fatty acid. As a fatty acid, a saturated fatty acid is used preferably. The number of carbon atoms of a fatty acid is preferably from 4 to 20, more preferably from 4 to 18, further preferably from 4 to 9, and especially preferably from 5 to 9. A polyolester may be a partial ester, in which a part of hydroxy groups of a polyhydric alcohol is not esterified and remains as a hydroxy group; may be a complete ester, in which all of hydroxy groups are esterified; or may be a mixture of a partial ester and a complete ester. The hydroxyl value of a polyolester is preferably 10 mg KOH/g or less, more preferably 5 mg KOH/g or less, and further preferably 3 mg KOH/g or less.

The ratio of C4 to C20 fatty acids in fatty acids constituting a polyolester is preferably from 20 to 100% by mole, more preferably from 50 to 100% by mole, further preferably from 70 to 100% by mole, and especially preferably from 90 to 100% by mole.

Specific examples of C4 to C20 fatty acids include butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, and icosanoic acid. The C4 to C20 fatty acids may be linear or branched. More specifically, a fatty acid having branches at α position and/or β position is preferable, and 2-methylpropanoic acid, 2-methylbutanoic acid, 2-methylpentanoic acid, 2-methylhexanoic acid, 2-ethylpentanoic acid, 2-methylheptanoic acid, 2-ethylhexanoic acid, 3,5,5-trimethylhexanoic acid, and 2-ethylhexadecanoic acid are more preferable. Among others, 2-ethylhexanoic acid, and 3,5,5-trimethylhexanoic acid are further preferable.

A fatty acid may contain a fatty acid other than a C4 to C20 fatty acid. Examples of a fatty acid other than a C4 to C20 fatty acid include C21 to C24 fatty acids, and specifically linear or branched henicosanoic acid, linear or branched docosanoic acid, linear or branched tricosanoic acid, and linear or branched tetracosanoic acid.

As a polyhydric alcohol constituting a polyolester, a polyhydric alcohol having 2 to 6 hydroxy groups may be used preferably. The number of carbon atoms of a polyhydric alcohol is preferably 4 or more, more preferably 5 or more; and is preferably 12 or less, and more preferably 10 or less. Specifically, a hindered alcohol, such as neopentyl glycol, trimethylolethane, trimethylolpropane, trimethylolbutane, di-(trimethylolpropane), tri-(trimethylolpropane), pentaerythritol, and dipentaerythritol, is preferable. A mixed ester with pentaerythritol, or with pentaerythritol and dipentaerythritol is more preferable, because the same is especially superior in compatibility with a refrigerant and hydrolysis stability.

A complex ester is an ester of a fatty acid and a dibasic acid with a monohydric alcohol and a polyol. As a fatty acid, a dibasic acid, a monohydric alcohol, and a polyol, those exemplified in the descriptions of a dibasic ester and a polyolester, or the like may be used.

A carbonic ester is a compound having a carbonic ester structure represented by the following formula (A) in a molecule. A carbonic ester may have one or more carbonic ester structures in a molecule.

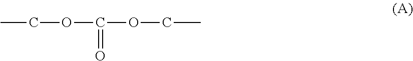

As an alcohol to constitute a carbonic ester the aliphatic alcohols, the polyols, and the like described above may be used, and also a product obtained by adding a polyglycol to a polyglycol or a polyol may be used. A carbonic ester may be constituted with carbonic acid and a fatty acid and/or a dibasic acid.

Among carbonic esters, a carbonic ester having a structure represented by the following formula (A-1) is preferable.

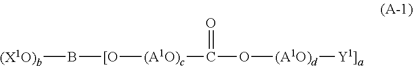

In the formula (A-1), X¹ represents a hydrogen atom, an alkyl group, a cycloalkyl group, or a group represented by the following formula (A-2):

Y²—(OA³)ₑ- (A-2)

(in the formula (A-2), Y² represents a hydrogen atom, an alkyl group, or a cycloalkyl group; A³ represents a C2 to C4 alkylene group; and e represents an integer of 1 to 50); A¹ and A² may be the same or different and each represent a C2 to C4 alkylene group; Y¹ represents a hydrogen atom, an alkyl group, or a cycloalkyl group; B represents a residue of a compound having 3 to 20 hydroxy groups; a represents an integer of 1 to 20, and b represents an integer of 0 to 19, wherein a+b=3 to 20; c represents an integer of 0 to 50; and d represents an integer of 1 to 50.]

In the formula (A-1), X¹ represents a hydrogen atom, an alkyl group, a cycloalkyl group, or a group represented by the above formula (A-2). Although there is no particular restriction on the number of carbon atoms of the alkyl group, it is ordinarily from 1 to 24, preferably from 1 to 18, and more preferably from 1 to 12. The alkyl group may be linear or branched.

Specific examples of a C1 to C24 alkyl group include a methyl group, an ethyl group, a n-propyl group, an isopropyl group, a n-butyl group, an isobutyl group, a sec-butyl group, a tert-butyl group, a linear or branched pentyl group, a linear or branched hexyl group, a linear or branched heptyl group, a linear or branched octyl group, a linear or branched nonyl group, a linear or branched decyl group, a linear or branched undecyl group, a linear or branched dodecyl group, a linear or branched tridecyl group, a linear or branched tetradecyl group, a linear or branched pentadecyl group, a linear or branched hexadecyl group, a linear or branched heptadecyl group, a linear or branched octadecyl group, a linear or branched nonadecyl group, a linear or branched icosyl group, a linear or branched henicosyl group, a linear or branched docosyl group, a linear or branched tricosyl group, and a linear or branched tetracosyl group.

Specific examples of a cycloalkyl group include a cyclopentyl group, a cyclohexyl group, and a cycloheptyl group.

Examples of a C2 to C4 alkylene group represented by A³ in the formula (A-2) include an ethylene group, a propylene group, a trimethylene group, a butylene group, a tetramethylene group, a 1-methyltrimethylene group, a 2-methyltrimethylene group, a 1,1-dimethylethylene group, and a 1,2-dimethylethylene group

In the formula (A-2), Y² is a hydrogen atom, an alkyl group, or a cycloalkyl group. Although there is no particular restriction on the number of carbon atoms of the alkyl group, it is ordinarily from 1 to 24, preferably from 1 to 18, and more preferably from 1 to 12. The alkyl group may be linear or branched. Specific examples of a C1 to C24 alkyl group include the groups exemplified in the description of X¹.

Specific examples of a cycloalkyl group include a cyclopentyl group, a cyclohexyl group, and a cycloheptyl group.

Among others, a hydrogen atom, or a C1 to C12 alkyl group is preferable as Y²; and a hydrogen atom, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a n-hexyl group, an isohexyl group, a n-heptyl group, an isoheptyl group, a n-octyl group, an isooctyl group, a n-nonyl group, an isononyl group, a n-decyl group, an isodecyl group, a n-undecyl group, an isoundecyl group, a n-dodecyl group, or an isododecyl group is more preferable.

As X¹, a hydrogen atom, a C1 to C12 alkyl group, or a group represented by the formula (A-2) is preferable; and a hydrogen atom, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a n-hexyl group, an isohexyl group, a n-heptyl group, an isoheptyl group, a n-octyl group, an isooctyl group, a n-nonyl group, an isononyl group, a n-decyl group, an isodecyl group, a n-undecyl group, an isoundecyl group, a n-dodecyl group, an isododecyl group, or a group represented by the formula (A-2) is more preferable.

Specific examples of a compound having 3 to 20 hydroxy groups leaving B as a residue include the aforedescribed polyols.

A¹ and A² may be the same or different and each represent a C2 to C4 alkylene group. Specific examples thereof include an ethylene group, a propylene group, a trimethylene group, a butylene group, a tetramethylene group, a 1-methyltrimethylene group, a 2-methyltrimethylene group, a 1,1-dimethylethylene group, and a 1,2-dimethylethylene group.

Y¹ is a hydrogen atom, an alkyl group, or a cycloalkyl group. Although there is no particular restriction on the number of carbon atoms of the alkyl group, it is ordinarily from 1 to 24, preferably from 1 to 18, and more preferably from 1 to 12. The alkyl group may be linear or branched. Specific examples of C1 to C24 alkyl groups include the groups listed in the description of X¹.

Specific examples of a cycloalkyl group include a cyclopentyl group, a cyclohexyl group, and a cycloheptyl group.

Among them, as Y¹, a hydrogen atom, or a C1 to C12 alkyl group is preferable, and a hydrogen atom, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a n-hexyl group, an isohexyl group, a n-heptyl group, an isoheptyl group, a n-octyl group, an isooctyl group, a n-nonyl group, an isononyl group, a n-decyl group, an isodecyl group, a n-undecyl group, an isoundecyl group, a n-dodecyl group, or an isododecyl group is more preferable.

In the formulas (A-1) and (A-2), c, d and e each represents the degree of polymerization of a polyoxyalkylene moiety. The polyoxyalkylene moieties may be the same or different from each other in a molecule. When a carbonic ester has a plurality of polyoxyalkylene moieties different from each other, there is no particular restriction on a polymerization type of oxyalkylene groups, and it may be random copolymerization, or block copolymerization.

A polyvinyl ether has a structural unit represented by the following formula (1).

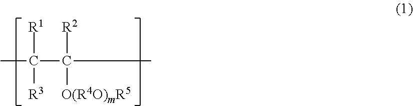

wherein R¹, R² and R³ may be the same or different from each other and each represent independently a hydrogen atom, or a hydrocarbon group; R⁴ represents a divalent hydrocarbon group, or a divalent ether-bonded oxygen-containing hydrocarbon group; R⁵ represents a hydrocarbon group; and m represents an integer of 0 or higher. When m is 2 or higher, a plurality of R⁴ may be the same or different from each other.

The number of carbon atoms of a hydrocarbon group represented by R¹, R² or R³ in the formula (1) is preferably 1 or more, more preferably 2 or more, and further preferably 3 or more, and preferably 8 or less, more preferably 7 or less, and further preferably 6 or less. At least one of R¹, R² and R³ in the formula (1) is preferably a hydrogen atom, and more preferably all of them are hydrogen atoms.

The number of carbon atoms of a divalent hydrocarbon group and an ether-bonded oxygen-containing hydrocarbon group represented by R⁴ in the formula (1) is preferably 1 or more, more preferably 2 or more, and further preferably 3 or more; and preferably 10 or less, more preferably 8 or less, and further preferably 6 or less. An ether-bonded oxygen-containing hydrocarbon group represented by R⁴ in the formula (1) may be, for example, a hydrocarbon group having oxygen in a side chain to form an ether bond.

R⁵ in the formula (1) is preferably a C1 to C20 hydrocarbon group. Examples of the hydrocarbon group include an alkyl group, a cycloalkyl group, a phenyl group, an aryl group, and an arylalkyl group. Among them, an alkyl group is preferable, and a C1 to C5 alkyl group is more preferable.

In the formula (1), m is preferably 0 or higher, more preferably 1 or higher, and further preferably 2 or higher; and preferably 20 or lower, more preferably 18 or lower, and further preferably 16 or lower. The average value of m in all structural units constituting polyvinyl ether is preferably from 0 to 10.

Polyvinyl ether may be a homopolymer constituted with one selected from structural units represented by the formula (1), may be a copolymer constituted with two or more selected from structural units represented by the formula (1), or may be a copolymer constituted with a structural unit represented by the formula (1) and another structural unit. When polyvinyl ether is a copolymer, lubricity, insulation properties, hygroscopicity, and the like can be further improved, while the compatibility of a refrigerating machine oil with a refrigerant is satisfied. In this case, various properties of the refrigerating machine oil as described above can be controlled to desired levels by selecting appropriately the kind of a monomer to be used as a source material, the kind of an initiator, the ratio of structural units in a copolymer, and the like Therefore a refrigerating machine oil meeting requirements on lubricity, compatibility, and the like which vary depending on a compressor type in a refrigerating system or an air-conditioning system, a material of a lubrication unit, a refrigerating capacity, the kind of a refrigerant, or the like, can be obtained freely. A copolymer may be either of a block copolymer, and a random copolymer.

When polyvinyl ether is a copolymer, it is preferable that the copolymer have a structural unit (1-1) represented by the formula (1) where R⁵ is a C1 to C3 alkyl group, and a structural unit (1-2) represented by the formula (1) where R⁵ is a C3 to C20, preferably C3 to C10, further preferably C3 to C8 alkyl group. As R⁵ in the structural unit (1-1), an ethyl group is especially preferable, and as R⁵ in the structural unit (1-2), an isobutyl group is especially preferable. When polyvinyl ether is a copolymer having structural units (1-1) and (1-2), the molar ratio of the structural unit (1-1) to the structural unit (1-2) is preferably from 5:95 to 95:5, more preferably from 20:80 to 90:10, and further preferably from 70:30 to 90:10. When the molar ratio is within the range, the compatibility with a refrigerant can be improved and the hygroscopicity tends to be lowered.

Although polyvinyl ether according to the present embodiment may be constituted solely with a structural unit represented by the formula (1), it may be also a copolymer having additionally a structural unit represented by the following formula (2). In such a case, the copolymer may be either of a block copolymer and a random copolymer.

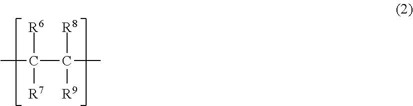

wherein R⁶ to R⁹ may be the same or different from each other and each represent independently a hydrogen atom or a C1 to C20 hydrocarbon group.

The polyvinyl ether may be produced by polymerization of a vinyl ether monomer according to the formula (1), or by copolymerization of a vinyl ether monomer according to the formula (1) and a hydrocarbon monomer with an olefinic double bond according to the formula (2). As a vinyl ether monomer according to a structural unit represented by the formula (1), a monomer represented by the following formula (3) is appropriate.

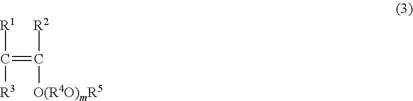

wherein R¹, R², R¹, R⁴, R⁵ and m areas defined for R¹, R², R³, R⁴, R⁵ and m, respectively, in the formula (1).

It is preferable that the polyvinyl ether have the following end structure (A) or (B).

(A) A structure, in which an end is represented by the formula (4) or (5), and the other end is represented by the formula (6) or (7).

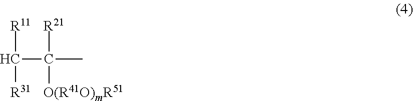

wherein R¹¹, R²¹ and R³¹ may be the same or different from each other and each represent independently a hydrogen atom or a C1 to C8 hydrocarbon group; R⁴¹ represents a C1 to C10 divalent hydrocarbon group, or divalent ether-bonded oxygen-containing hydrocarbon group; R⁵¹ represents a C1 to 20 hydrocarbon group; and m has the same defined meaning as m in the formula (1). When m is 2 or higher, a plurality of R⁴¹ may be the same or different from each other.

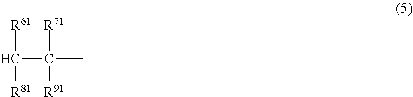

wherein, R⁶¹, R⁷¹, R⁸¹ and R⁹¹ may be the same or different from each other and each represent independently a hydrogen atom or a C1 to C20 hydrocarbon group.

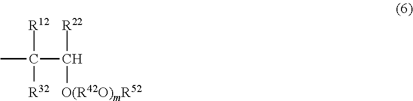

wherein, R¹², R²² and R³² may be the same or different from each other and each represent independently a hydrogen atom or a C1 to C8 hydrocarbon group; R⁴² represents a C1 to C10 divalent hydrocarbon group or divalent ether-bonded oxygen-containing hydrocarbon group; R⁵² represents a C1 to 20 hydrocarbon group; and m has the same defined meaning as m in the formula (1). When m is 2 or higher, a plurality of R⁴¹ may be the same or different.

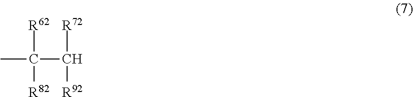

wherein, R⁶², R⁷², R⁸² and R⁹² may be the same or different from each other and each represent independently a hydrogen atom or a C1 to C20 hydrocarbon group.

(B) A structure, in which an end is represented by the formula (4) or (5), and the other end is represented by the following formula (8).

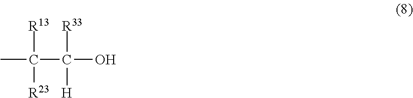

wherein, R¹³, R²³ and R³³ may be the same or different from each other and each represent independently a hydrogen atom or a C1 to C8 hydrocarbon group.

Among the polyvinyl ethers, polyvinyl ethers of (a), (b), (c), (d) and (e) described below are especially appropriate as a main component (base oil) of a refrigerating machine oil.

(a) Polyvinyl ether having a structure, in which an end is represented by the formula (4) or (5), and the other end is represented by the formula (6) or (7), wherein in the formula (1) all of R¹, R² and R³ are a hydrogen atom; m is an integer of 0 to 4; R⁴ is a C2 to C4 divalent hydrocarbon group; and R⁵ is a C1 to C20 hydrocarbon group.
(b) Polyvinyl ether having solely a structural unit represented by the formula (1), and a structure, in which an end is represented by the formula (4), and the other end is represented by the formula (6), wherein in the formula (1) all of R¹, R² and R³ are a hydrogen atom; m is an integer of 0 to 4; R⁴ is a C2 to C4 divalent hydrocarbon group; and R⁵ is a C1 to C20 hydrocarbon group.
(c) Polyvinyl ether having a structure, in which an end is represented by the formula (4) or (5), and the other end is represented by the formula (8), wherein in the formula (1) all of R¹, R² and R³ are a hydrogen atom; m is an integer of 0 to 4; R⁴ is a C2 to C4 divalent hydrocarbon group; and R⁵ is a C1 to C20 hydrocarbon group.
(d) Polyvinyl ether having solely a structural unit represented by the formula (1), and a structure, in which an end is represented by the formula (5), and the other end is represented by the formula (8), wherein in the formula (1) all of R¹, R² and R³ are a hydrogen atom; m is an integer of 0 to 4; R⁴ is a C2 to C4 divalent hydrocarbon group; and R⁵ is a C1 to C20 hydrocarbon group.
(e) Polyvinyl ether of any one of the above (a), (b), (c), and (d), having a structural unit, in which R⁵ in the formula (1) is a C1 to C3 hydrocarbon group, and a structural unit, in which the R⁵ is a C3 to C20 hydrocarbon group.

Although in a production process for polyvinyl ether, an unsaturated group such as an aryl group may be formed in a molecule due to a possible side reaction, polyvinyl ether with a low degree of unsaturation to be caused by an unsaturated group, and the like is preferable as polyvinyl ether from the viewpoints of enhancement of the thermal stability of polyvinyl ether itself, suppression of sludge generation due to polymer formation, and suppression of formation of a peroxide due to deterioration of antioxidative properties (oxidation resistance). The degree of unsaturation of polyvinyl ether is preferably 0.04 meq/g or less, more preferably 0.03 meq/g or less, and further preferably 0.02 meq/g or less. The peroxide value of polyvinyl ether is preferably 10.0 meq/kg or less, more preferably 5.0 meq/kg or less, and further preferably 1.0 meq/kg. The carbonyl value of polyvinyl ether is preferably 100 ppm by weight or less, more preferably 50 ppm by weight or less, and further preferably 20 ppm by weight or less. The hydroxyl value of polyvinyl ether is preferably 10 mg KOH/g or less, more preferably 5 mg KOH/g or less, and further preferably 3 mg KOH/g or less.

The degree of unsaturation, a peroxide value, and a carbonyl value as used herein are each a value measured according to the Standard Methods for the Analysis of Fats, Oils and Related Materials established by Japan Oil Chemists' Society. Namely, with respect to the degree of unsaturation as used herein, a sample is reacted with a Wijs solution (ICl-acetic acid solution), the reaction liquid is left standing in a dark place, then excessive ICl is reduced to iodine, the iodine analyte is titrated with sodium thiosulfate to calculate an iodine value, and the iodine value is reduced to a vinyl equivalent value (meq/g) as the degree of unsaturation. With respect to peroxide value as used herein, potassium iodide is added to a sample, the produced free iodine is measured by titration with sodium thiosulfate, and the free iodine amount is reduced to milliequivalent figure based on 1 kg of sample (meq/kg) as a peroxide value. With respect to carbonyl value as used herein, 2,4-dinitrophenyl hydrazine is reacted with a sample to generate a chromogenic quinoid ion, the absorbance at 480 nm is measured for the reacted sample, and a value reduced to a carbonyl amount (ppm by weight) is determined as a carbonyl value based on a calibration curve prepared in advance using cinnamaldehyde as a standard material. A hydroxyl value as used herein means a hydroxyl value measured according to JIS K0070: 1992.

Polyalkylene glycol may have various chemical structures, and examples of a basic compound thereof include polyethylene glycol, polypropylene glycol, and polybutylene glycol. Unit structures of polyalkylene glycol are oxyethylene, oxypropylene, and oxybutylene.

Polyalkylene glycols having such unit structures can be produced by ring-opening polymerization using ethylene oxide, propylene oxide, or butylene oxide, respectively, as a source material monomer.

Examples of polyalkylene glycol include a compound represented by the following formula (9).

R^{α}—[(OR^{β})_{f}OR^{γ}]_{g} (9)

(In Formula (1), R^{α} represents a hydrogen atom, a C1 to C10 alkyl group, a C2 to C10 acyl group, or a residue of a compound having 2 to 8 hydroxy groups; R^{β} represents a C2 to C4 alkylene group; R^{γ} represents a hydrogen atom, a C1 to C10 alkyl group, or a C2 to C10 acyl group; f represents an integer of 1 to 80; and g represents an integer of 1 to 8.)

An alkyl group represented by R^{α}, or R^{γ} in the formula (9) may be any of linear, branched, and cyclic. The number of carbon atoms of the alkyl group is preferably from 1 to 10, and more preferably from 1 to 6. When the number of carbon atoms of the alkyl group is beyond 10, the compatibility with a refrigerant tends to decline.

An alkyl group moiety of an acyl group represented by R^{α}, or R^{γ} may be any of linear, branched, and cyclic. The number of carbon atoms of the acyl group is preferably from 2 to 10, and more preferably from 2 to 6. When the number of carbon atoms of the acyl group is beyond 10, the compatibility with a refrigerant decreases, so that phase separation may occur.

When groups represented by R^{α}, and R^{γ} are both alkyl groups, or both acyl groups, the groups represented by R^{α}, and R^{γ} may be the same or different. When g is 2 or higher, a plurality of groups represented by R^{α} and R^{γ} in the same molecule may be the same or different.

In a case where a group represented by R^{α} is a residue of a compound having 2 to 8 hydroxy groups, the compound may be open-chain or cyclic.

With respect to polyalkylene glycol represented by the formula (9), at least one of R^{α}, and R^{γ} is preferably an alkyl group (more preferably a C1 to C4 alkyl group), and especially preferably a methyl group from the viewpoint of compatibility with a refrigerant.

From the viewpoint of thermal and chemical stability, both of R^{α} and R^{γ} are preferably an alkyl group (more preferably a C1 to C4 alkyl group), and further preferably both are methyl groups.

From the viewpoints of production easiness and cost, it is preferable that either one of R^{α} and R^{γ} be an alkyl group (more preferably a C1 to C4 alkyl group), and the other be a hydrogen atom, and more preferable that one be a methyl group and the other be a hydrogen atom. From the viewpoints of lubricity and sludge solubility, it is preferable that R^{α} and R^{γ} be each a hydrogen atom.

R^{β} in the formula (9) represents a C2 to C4 alkylene group, and specific examples of such an alkylene group include an ethylene group, a propylene group, and a butylene group. Examples of an oxyalkylene group, which is a recurring unit represented by OR^{β}, include an oxyethylene group, an oxypropylene group, and an oxybutylene group. Meanwhile, an oxyalkylene group represented by (OR^{β})_{f} may be composed of one oxyalkylene group, or composed of two or more oxyalkylene groups.

Among polyalkylene glycols represented by the formula (9), a copolymer including an oxyethylene group (EO) and an oxy propylene group (PO) is preferable from the viewpoints of compatibility with a refrigerant and viscosity-temperature characteristics. In this case, from the viewpoints of seizure load, and viscosity-temperature characteristics, the content of oxyethylene group based on the total of oxyethylene group and oxy propylene group (EO/(PO+EO)) is preferably in a range of 0.1 to 0.8, and more preferably in a range of 0.3 to 0.6.

From the viewpoints of hygroscopicity and thermal and oxidative stability, EO/(PO+EO) is preferably in a range of 0 to 0.5, more preferably in a range of 0 to 0.2, and most preferably 0 (namely, a propylene oxide homopolymer).

In the formula (9), f means a repetition number (degree of polymerization) of an oxyalkylene group OR^{β}, and is an integer of 1 to 80. Meanwhile g is an integer of 1 to 8. For example, when R^{α} is an alkyl group or an acyl group, g is 1. When R^{α} is a residue of a compound having 2 to 8 hydroxy groups, g is equal to the number of hydroxy groups owned by the compound.

Although there is no particular restriction on the product of f and g (f×g), the average value of f×g is preferably 6 to 80 for the sake of well-balanced satisfaction of the required performances described above as a refrigerating machine oil.

The number average molecular weight of polyalkylene glycol represented by formula (9) is preferably 500 or higher, and more preferably 600 or higher; and preferably 3000 or lower, more preferably 2000 or lower, and further preferably 1500 or lower. In the formula (9), f and g are preferably numbers that allow the number average molecular weight of polyalkylene glycol to satisfy the above condition. When the number average molecular weight of polyalkylene glycol is too low, the lubricity tends to become insufficient in the coexistence of a refrigerant. On the contrary, when the number average molecular weight is too high, the composition range, where favorable compatibility with a refrigerant is exhibited also at a low temperature, is narrowed, so that poor lubrication in a refrigerant compressor, or impediment of heat exchange in an evaporator becomes apt to occur.

There is no particular restriction on the hydroxyl value of polyalkylene glycol, and it is preferably 100 mg KOH/g or less, more preferably 50 mg KOH/g or less, further preferably 30 mg KOH/g or less, and most preferably 10 mg KOH/g or less.

A polyalkylene glycol can be synthesized using a publicly known method (“Alkylene oxide polymer”, Shibata Mitsuta et al., Kaibundo, published on 20 Nov. 1990). For example, to an alcohol (R^{α}OH; R^{α} is as defined for R^{α} in the formula (9)) one or more predetermined alkylene oxides are addition-polymerized, and further a terminal hydroxy group is etherified or esterified to yield a polyalkylene glycol represented by the formula (9). In a case where two or more alkylene oxides are used in the production process, an obtainable polyalkylene glycol may be either of a random copolymer and a block copolymer; however from the viewpoint of tending to be superior in oxidative stability and lubricity, a block copolymer is preferable, but from the viewpoint of tending to be superior in low temperature flowability, a random copolymer is preferable.

The kinematic viscosity of polyalkylene glycol at 100° C. is preferably 5 mm²/s or more, more preferably 6 mm²/s or more, further preferably 7 mm²/s or more, especially preferably 8 mm²/s or more, and most preferably 10 mm²/s or more; and preferably 20 mm²/s or less, more preferably 18 mm²/s or less, further preferably 16 mm²/s or less, especially preferably 15 mm²/s or less, and most preferably 15 mm²/s or less. When the kinematic viscosity at 100° C. is less than the lower limit, the lubricity in the coexistence of a refrigerant becomes insufficient, on the other hand when it exceeds the upper limit, the composition range, where favorable compatibility with a refrigerant is exhibited, is narrowed, so that poor lubrication in a refrigerant compressor, or impediment of heat exchange in an evaporator becomes apt to occur. The kinematic viscosity of polyalkylene glycol at 40° C. is preferably 10 mm²/s or more, and more preferably 20 mm²/s or more; and preferably 200 mm²/s or less, and more preferably 150 mm²/s or less. When the kinematic viscosity at 40° C. is less than 10 mm²/s, the lubricity or sealing of a compressor tends to deteriorate, and when it exceeds 200 mm²/s, the composition range, where favorable compatibility with a refrigerant is exhibited also at a low temperature, is narrowed, so that poor lubrication in a refrigerant compressor, or impediment of heat exchange in an evaporator tends to occur easier.

The pour point of polyalkylene glycol is preferably −10° C. or lower, and more preferably −20° C. or lower; and is preferably −50° C. or higher. When a polyalkylene glycol with a pour point of −10° C. or higher is used, a refrigerating machine oil tends to solidify in a refrigerant circulation system at a low temperature.

In a production process of polyalkylene glycol represented by the formula (9), an alkylene oxide such as propylene oxide may occasionally cause a side reaction to form an unsaturated group such as an aryl group in a molecule. When an unsaturated group is formed in a polyalkylene glycol molecule, such a phenomenon that the thermal stability of polyalkylene glycol itself is lowered, that sludge is generated through formation of polymers, or that a peroxide is formed due to deterioration of antioxidative properties (oxidation resistance), is apt to occur. Especially, if a peroxide is formed, it will be degraded to form a compound having a carbonyl group, and then the compound having a carbonyl group generates sludge to clog frequently a capillary.

Therefore, as polyalkylene glycol, a polyalkylene glycol with a low degree of unsaturation originated from an unsaturated group, and the like is preferable. The degree of unsaturation of polyalkylene glycol is preferably 0.04 meq/g or less, more preferably 0.03 meq/g or less, and most preferably 0.02 meq/g or less. The peroxide value is preferably 10.0 meq/kg or less, more preferably 5.0 meq/kg or less, and most preferably 1.0 meq/kg. The carbonyl value is preferably 100 ppm by weight or less, more preferably 50 ppm by weight or less, and most preferably 20 ppm by weight or less.

For obtaining a polyalkylene glycol with a low degree of unsaturation, a low peroxide value, and a low carbonyl value, the reaction temperature for reacting propylene oxide is preferably 120° C. or less, and more preferably 110° C. or less. In a case where an alkali catalyst is used during production, for removing the same, an inorganic adsorption agent, such as active carbon, activated clay, bentonite, dolomite, and aluminosilicate, may be used, so that the degree of unsaturation is reduced. Increase of peroxide value, or carbonyl value can be also prevented by avoiding contact with oxygen to the extent possible during production or actual use of polyalkylene glycol, or by adding an antioxidant.

It is necessary for polyalkylene glycol to have a carbon/oxygen molar ratio within a certain range, and a polymer, in which the molar ratio is within the range, can be produced by selecting or adjusting the type of source material monomers, and the mixing ratio.

A base oil may further contain, for example, a hydrocarbon oil, such as a mineral oil, an olefin polymer, a naphthalene compound, and an alkylbenzene in addition to the oxygen-containing oil. The content of the oxygen-containing oil is preferably 5 mass % or more based on the total amount of a base oil, more preferably 30 mass % or more, and further preferably 95 mass % or more.

A refrigerating machine oil may, if necessary, contain additionally various additives. Examples of the additives include an acid scavenger, an antioxidant, an extreme-pressure agent, an oiliness agent, an antifoaming agent, a metal deactivator, an antiwear agent, a viscosity index improver, a pour-point depressant, a detergent dispersant, a friction modifier, and a rust inhibitor. The additive content is preferably 5 mass % or less based on the total amount of a refrigerating machine oil, and more preferably 2 mass % or less.

A refrigerating machine oil preferably contains an acid scavenger among the listed additives from the viewpoints of improvement in thermal and chemical stability. Examples of an acid scavenger include an epoxy compound, and a carbodiimide compound.

There is no particular restriction on an epoxy compound, and examples thereof include a glycidyl ether type epoxy compound, a glycidyl ester type epoxy compound, an oxirane compound, an alkyloxirane compound, an alicyclic epoxy compound, an epoxidized fatty acid monoester, and an epoxidized vegetable oil. The epoxy compounds may be used singly or in combinations of two or more.

Examples of a glycidyl ether type epoxy compound include n-butylphenyl glycidyl ether, i-butylphenyl glycidyl ether, sec-butylphenyl glycidyl ether, tert-butylphenyl glycidyl ether, pentylphenyl glycidyl ether, hexylphenyl glycidyl ether, heptylphenyl glycidyl ether, octylphenyl glycidyl ether, nonylphenyl glycidyl ether, decylphenyl glycidyl ether, decyl glycidyl ether, undecyl glycidyl ether, dodecyl glycidyl ether, tridecyl glycidyl ether, tetradecyl glycidyl ether, 2-ethylhexyl glycidyl ether, neopentyl glycol diglycidyl ether, trimethylolpropane triglycidyl ether, pentaerythritol tetraglycidyl ether, 1,6-hexanediol diglycidyl ether, sorbitol polyglycidyl ether, polyalkylene glycol monoglycidyl ether, and polyalkylene glycol diglycidyl ether.

Examples of a glycidyl ester type epoxy compound include glycidyl benzoate, glycidyl neodecanoate, glycidyl-2,2-dimethyl octanoate, glycidyl acrylate, and glycidyl methacrylate.

An alicyclic epoxy compound is a compound having a partial structure represented by the following formula (10), in which carbon atoms constituting an epoxy group are direct constituents of an alicyclic ring.

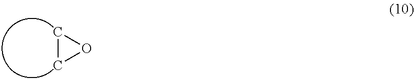

Examples of an alicyclic epoxy compound include 1,2-epoxycyclohexane, 1,2-epoxycyclopentane, 3′,4′-epoxycyclohexyl-methyl-3,4-epoxycyclohexane carboxylate, bis(3,4-epoxycyclohexylmethypadipate, exo-2,3-epoxynorbornane, bis(3,4-epoxy-6-methylcyclohexylmethyl)adipate, 2-(7-oxabicyclo [4.1.0]hept-3-yl)-spiro(1,3-dioxane-5,3′-[7]oxabicyclo [4.1.0]heptane), 4-(1′-methylepoxyethyl)-1,2-epoxy-2-methylcyclohexane, and 4-epoxyethyl-1,2-epoxycyclohexane.

Examples of an allyloxirane compound include 1,2-epoxystyrene, and alkyl-1,2-epoxystyrene.

Examples of an alkyloxirane compound include 1,2-epoxybutane, 1,2-epoxypentane, 1,2-epoxyhexane, 1,2-epoxyheptane, 1,2-epoxyoctane, 1,2-epoxynonane, 1,2-epoxydecane, 1,2-epoxyundecane, 1,2-epoxydodecane, 1,2-epoxytridecane, 1,2-epoxytetradecane, 1,2-epoxypentadecane, 1,2-epoxyhexadecane, 1,2-epoxyheptadecane, 1,1,2-epoxyoctadecane, 2-epoxynonadecane, and 1,2-epoxyicosane.

Examples of an epoxidized fatty acid monoester include an ester of an epoxidized C12 to C20 fatty acid with a C1 to C8 alcohol, or phenol or alkyl phenol. As an epoxidized fatty acid monoester, butyl-, hexyl-, benzyl-, cyclohexyl-, methoxyethyl-, octyl-, phenyl- and butylphenyl-esters of epoxystearic acid may be used preferably.

Examples of an epoxidized vegetable oil include an epoxy compound of a vegetable oil, such as a soybean oil, a linseed oil, and a cottonseed oil.

There is no particular restriction on a carbodiimide compound, and, for example, a dialkylcarbodiimide, diphenylcarbodiimide, and a bis(alkylphenyl)carbodiimide may be used. Examples of a dialkylcarbodiimide include diisopropylcarbodiimide, and dicyclohexylcarbodiimide. Examples of a bis(alkylphenyl)carbodiimide include ditolylcarbodiimide, bis(isopropylphenyl)carbodiimide, bis(diisopropylphenyl)carbodiimide, bis(triisopropylphenyl)carbodiimide, bis(butylphenyl)carbodiimide, bis(dibutylphenyl)carbodiimide, and bis(nonylphenyl)carbodiimide.

It is preferable that a refrigerating machine oil further contain, among the above additives, an antiwear agent. Examples of a suitable antiwear agent include a phosphoric ester, a thiophosphoric ester, a sulfide compound, and a zinc dialkyldithiophosphate. Among phosphoric esters triphenyl phosphate (TPP), and tricresyl phosphate (TCP) are preferable. Among thiophosphoric esters, triphenylphosphorothionate (TPPT) is preferable. Although there are many sulfide compounds, a monosulfide compound is preferable, because the stability of a refrigerating machine oil can be secured, and deterioration of copper broadly used in a refrigerating machine can be suppressed.

It is preferable that a refrigerating machine oil further contain, among the above additives, an antioxidant. Examples of an antioxidant include phenol compounds such as di-tert-butyl-p-cresol, and amine compounds such as an alkyl diphenyl amine. It is especially preferable that a refrigerating machine oil contain a phenol compound as an antioxidant from 0.02 mass % or more to 0.5 mass % or less based on the total amount of refrigerating machine oil.

It is preferable that a refrigerating machine oil further contain, among the above additives, a friction modifier, an extreme-pressure agent, a rust inhibitor, a metal deactivator, and an antifoaming agent. Examples of a friction modifier include an aliphatic amine, an aliphatic amide, an aliphatic imide, an alcohol, an ester, a phosphoric ester amine salt, and a phosphite ester amine salt. Examples of an extreme-pressure agent include sulfurized olefin, and sulfurized oil. Examples of a rust inhibitor include an ester or partial ester of an alkenyl succinic acid. Examples of a metal deactivator include benzotriazole, and a benzotriazole derivative. Examples of an antifoaming agent include a silicone compound, and a polyester compound.

The content of a base oil in a refrigerating machine oil is preferably 80 mass % or more based on the total amount of a refrigerating machine oil, more preferably 90 mass % or more, and further preferably 95 mass % or more in order to be superior in characteristics required for a refrigerating machine oil, such as lubricity, compatibility, thermal and chemical stability, and electrical insulation.

The kinematic viscosity of a refrigerating machine oil at 40° C. may be preferably 3 mm²/s or more, more preferably 4 mm²/s or more, and further preferably 5 mm²/s or more; and may be preferably 1000 mm²/s or less, more preferably 500 mm²/s or less, and further preferably 400 mm²/s or less. The kinematic viscosity of a refrigerating machine oil at 100° C. may be preferably 1 mm²/s or more, and more preferably 2 mm²/s or more; and may be preferably 100 mm²/s or less, and more preferably 50 mm²/s or less.

Although there is no particular restriction on the volume resistivity of a refrigerating machine oil, it may be preferably 1.0×10⁹ Ω·m or more, more preferably 1.0×10¹⁰ Ω·m or more, and most preferably 1.0×10¹¹ Ω·m or more. Especially, when a refrigerating machine oil is used in a closed refrigerating machine, a high electrical insulation tends to be required. A volume resistivity as used herein means a value measured at 25° C. according to JIS C2101: 1999 “Testing methods of electrical insulating oils”.

Although there is no particular restriction on the moisture content of a refrigerating machine oil, it may be preferably 200 ppm or less based on the total amount of a refrigerating machine oil, more preferably 100 ppm or less, and most preferably 50 ppm or less. Especially, when a refrigerating machine oil is used in a closed refrigerating machine, a low moisture content is required from the viewpoints of the thermal and chemical stability of a refrigerating machine oil, or influence on electrical insulation.

Although there is no particular restriction on the acid value of a refrigerating machine oil, it may be preferably 1.0 mg KOH/g or less, and more preferably 0.1 mg KOH/g or less in order to prevent corrosion of a metal used for a refrigerating machine or piping, and to prevent degradation of an ester in a case where an ester is contained in a refrigerating machine oil. An acid value as used herein means an acid value measured according to JIS K2501: 2003 “Petroleum products and lubricants-Determination of neutralization number”.

Although there is no particular restriction on the ash content in a refrigerating machine oil, it may be preferably 100 ppm or less, and more preferably 50 ppm or less for the sake of enhancement of thermal and chemical stability, and suppression of generation of sludge, and the like. An ash content as used herein means an ash content measured according to JIS K2272: 1998 “Crude oil and petroleum products-Determination of ash and sulfated ash”.

The pour point of a refrigerating machine oil may be preferably −10° C. or less, more preferably −20° C. or less, and further preferably −30° C. or less. A pour point as used herein means a pour point measured according to JIS K2269.

A composition containing as a base oil at least one oxygen-containing oil with the carbon/oxygen molar ratio of 2.5 or more and 5.8 or less, and a composition containing as a base oil at least one oxygen-containing oil with the carbon/oxygen molar ratio of 2.5 or more and 5.8 or less, and further containing various additives described above are favorably utilized as a constituent of a refrigerating machine oil to be used together with a 1-chloro-3,3,3-trifluoropropene refrigerant, or as a constituent of a working fluid composition for a refrigerating machine containing a refrigerating machine oil and a 1-chloro-3,3,3-trifluoropropene refrigerant.

A composition containing as a base oil at least one oxygen-containing oil with the carbon/oxygen molar ratio of 2.5 or more and 5.8 or less, and a composition containing as a base oil at least one oxygen-containing oil with the carbon/oxygen molar ratio of 2.5 or more and 5.8 or less, and further containing various additives described above are favorably utilized for producing a refrigerating machine oil to be used together with a 1-chloro-3,3,3-trifluoropropene refrigerant, or for producing a working fluid composition for a refrigerating machine containing a refrigerating machine oil and a 1-chloro-3,3,3-trifluoropropene refrigerant.

A refrigerating machine oil according to the present embodiment is used together with a 1-chloro-3,3,3-trifluoropropene (1233zd) refrigerant. A working fluid composition for a refrigerating machine according to the present embodiment contains a 1-chloro-3,3,3-trifluoropropene (1233zd) refrigerant. The 1-chloro-3,3,3-trifluoropropene (1233zd) may be any of cis-1-chloro-3,3,3-trifluoropropene (1233 zd(Z)), trans-1-chloro-3,3,3-trifluoropropene (1233zd(E)), and a mixture thereof.

A refrigerant to be used with a refrigerating machine oil according to the present embodiment, and a refrigerant that a working fluid composition for a refrigerating machine according to the present embodiment contains, may further contain a publicly known refrigerant, such as a saturated fluorohydrocarbon refrigerant, and an unsaturated fluorohydrocarbon refrigerant, in addition to 1-chloro-3,3,3-trifluoropropene (1233zd). The content of 1-chloro-3,3,3-trifluoropropene (1233zd) is preferably 90 mass % or less based on the total amount of a refrigerant, more preferably 60 mass % or less, further preferably 50 mass % or less, especially preferably 40 mass % or less, and most preferably 20 mass % or less from the viewpoint of the stability of a refrigerating machine oil in an atmosphere of a refrigerant. The content of 1-chloro-3,3,3-trifluoropropene (1233zd) is preferably 20 mass % or more based on the total amount of a refrigerant, more preferably 40 mass % or more, further preferably 50 mass % or more, especially preferably 60 mass % or more, and most preferably 90 mass % or more from the viewpoint of reduction of GWP.

Examples of a saturated fluorohydrocarbon refrigerant include any one or a mixture of two or more selected from the group consisting of difluoromethane (HFC-32), pentafluoroethane (HFC-125), 1,1,2,2-tetrafluoroethane (HFC-134), 1,1,1,2-tetrafluoroethane (HFC-134a), 1,1-difluoroethane (HFC-152a), fluoroethane (HFC-161), 1,1,1,2,3,3,3-heptafluoropropane (HFC-227ea), 1,1,1,2,3,3-hexafluoropropane (HFC-236 ea), 1,1,1,3,3,3-hexafluoropropane (HFC-236fa), 1,1,1,3,3-pentafluoropropane (HFC-245 fa), and 1,1,1,3,3-pentafluorobutane (HFC-365mfc). Among them difluoromethane (HFC-32), and 1,1,1,2-tetrafluoroethane (HFC-134a) are preferable from the viewpoints of the stability of a refrigerating machine oil in an atmosphere of a refrigerant and reduction of GWP.

Examples of an unsaturated fluorohydrocarbon refrigerant include any one or a mixture of two or more selected from the group consisting of 1,2,3,3,3-pentafluoroprop ene (HFC-1225ye), 1,3,3,3-tetrafluoropropene (HFC-1234 ze), 2,3,3,3-tetrafluoroprop ene (HFC-1234yf), 1,2,3,3-tetrafluoropropene (HFC-1234ye), and 3,3,3-trifluoropropene (HFC-1243zf). Among them 2,3,3,3-tetrafluoropropene (HFC-1234yf) is preferable from the viewpoints of the stability of a refrigerating machine oil in an atmosphere of a refrigerant and reduction of GWP.

Although there is no particular restriction on the content of a refrigerating machine oil in a working fluid composition for a refrigerating machine, it may be preferably 1 part by mass or more based on 100 parts by mass of a refrigerant, and more preferably 2 parts by mass or more; and may be preferably 500 parts by mass or less, and more preferably 400 parts by mass or less.

A working fluid composition for a refrigerating machine according to the present embodiment is used advantageously in a room air-conditioner, a refrigerator, or an open- or closed type car air-conditioner provided with a reciprocal or rotary closed type compressor. A working fluid composition for a refrigerating machine, and a refrigerating machine oil according to the present embodiment are used advantageously in a cooling device, and the like such as a dehumidifier, a water heater, a freezer, a refrigerator/freezer storehouse, an automatic vending machine, a showcase, and a chemical plant. A working fluid composition for a refrigerating machine, and a refrigerating machine oil according to the present embodiment are also used advantageously in a device provided with a centrifugal compressor.

### Examples

The present invention will be described below more specifically by way of Examples, provided that the present invention be not limited to the following Examples.

As base oils 1 to 8 polyolesters between a fatty acid and a polyhydric alcohol with a composition set forth in Table 1 or 2 were prepared. Abbreviations in the tables stand for the following compounds.

iC4: 2-methylpropanoic acid
nC5: n-pentanoic acid
iC8: 2-ethylhexanoic acid
iC9: 3,5,5-trimethylhexanoic acid
nC10: n-decanoic acid
iC18: 2-ethylhexadecanoic acid
nC22: docosanoic acid
PET: pentaerythritol

TABLE 1

| | | Base oil 1 | Base oil 2 | Base oil 3 | Base oil 4 |
|---|---|---|---|---|---|
| Fatty acid | iC4 | — | 35 | — | — |
| composition | nC5 | — | — | 40 | — |
| (% by mole) | iC8 | 50 | — | — | — |
| | iC9 | 50 | 65 | 60 | — |
| | nC10 | — | — | — | 100 |
| | iC18 | — | — | — | — |
| | nC22 | — | — | — | — |

| | | | | |
|---|---|---|---|---|
| Polyhydric alcohol | PET | PET | PET | PET |

TABLE 2

| | | Base oil 5 | Base oil 6 | Base oil 7 | Base oil 8 |
|---|---|---|---|---|---|
| Fatty acid | iC4 | — | — | 40 | — |
| composition | nC5 | — | 80 | — | — |
| (% by mole) | iC8 | 50 | — | — | — |
| | iC9 | — | 20 | — | — |
| | nC10 | — | — | — | — |
| | iC18 | 50 | — | — | — |
| | nC22 | — | — | 60 | 100 |

| | | | | |
|---|---|---|---|---|
| Polyhydric alcohol | PET | PET | PET | PET |

Sample oils 1 to 10 with a composition shown in Table 3 or 4 were prepared using the base oils 1 to 8 and the following additives.

Additive 1: glycidyl neodecanoate
Additive 2: 2-ethylhexyl glycidyl ether
Additive 3: tricresyl phosphate
Additive 4: 2,6-di-tert-butyl-p-cresol

The following stability test was conducted on each sample oil. The results are shown in Tables 3 and 4.

(Stability Test)

A stability test was conducted according to JIS K2211: 2009 (Autoclave test). Specifically, 80 g of a sample oil conditioned to a moisture content of 100 ppm was weighed out and placed in an autoclave, to which a catalyst (iron wire, copper wire, and aluminum wire, each having an outer diameter of 1.6 mm, and a length of 50 mm), and 20 g of a trans-1-chloro-3,3,3-trifluoropropene (1233zd(E)) refrigerant were placed and after closing the autoclave was heated to 140° C. After 160 hours the acid value (JIS C2101: 1999) of the sample oil was measured.

TABLE 3

| | | Sample | Sample | Sample | Sample | Sample |
|---|---|---|---|---|---|---|
| | | oil 1 | oil 2 | oil 3 | oil 4 | oil 5 |
| Sample oil | Base oil 1 | 100 | — | — | — | — |
| composition | Base oil 2 | — | 100 | — | — | — |
| (mass %, | Base oil 3 | — | — | 100 | — | — |
| based on | Base oil 4 | — | — | — | 100 | — |
| total mass of | Base oil 5 | — | — | — | — | 100 |
| sample oil) | Base oil 6 | — | — | — | — | — |
| | Base oil 7 | — | — | — | — | — |
| | Base oil 8 | — | — | — | — | — |
| | Additive 1 | — | — | — | — | — |
| | Additive 2 | — | — | — | — | — |
| | Additive 3 | — | — | — | — | — |
| | Additive 4 | — | — | — | — | — |

| | | | | | |
|---|---|---|---|---|---|
| Stability Acid | 0.23 | 0.35 | 0.51 | 0.88 | 0.52 |
| value (mgKOH/g) | | | | | |

TABLE 4

| | | Sample | Sample | Sample | Sample | Sample |
|---|---|---|---|---|---|---|
| | | oil 6 | oil 7 | oil 8 | oil 9 | oil 10 |
| Sample oil | Base oil 1 | — | 99.5 | — | — | — |
| composition | Base oil 2 | — | — | — | — | — |
| (mass %, | Base oil 3 | — | — | 99.4 | — | — |
| based on | Base oil 4 | — | — | — | — | — |
| total mass of | Base oil 5 | — | — | — | — | — |
| sample oil) | Base oil 6 | 100 | — | — | — | — |
| | Base oil 7 | — | — | — | 100 | — |
| | Base oil 8 | — | — | — | — | 100 |
| | Additive 1 | — | 0.1 | 0.5 | — | — |
| | Additive 2 | — | 0.1 | — | — | — |
| | Additive 3 | — | 0.1 | — | — | — |
| | Additive 4 | — | 0.2 | 0.1 | — | — |

| | | | | | |
|---|---|---|---|---|---|
| Stability Acid | 0.77 | 0.05 | 0.06 | 1.55 | 1.21 |
| value (mgKOH/g) | | | | | |

The following refrigerant compatibility test was conducted on the sample oils 1 to 10 to have confirmed that all the sample oils were compatible with the refrigerant.

(Refrigerant Compatibility Test)

According to “Test method for compatibility with refrigerant” in JIS K2211:2009 “Refrigerating machine oils”, 10 g of a sample oil was blended with 10 g of a trans-1-chloro-3,3,3-trifluoropropene (1233zd(E)) refrigerant, and the blend was observed to find whether the refrigerant and the refrigerating machine oil were mutually dissolved at 0° C.

1. A refrigerating machine oil comprising, as a base oil, at least one oxygen-containing oil having a carbon/oxygen molar ratio of 2.5 or more and 5.8 or less, and
the refrigerating machine oil being utilized with a 1-chloro-3,3,3-trifluoropropene refrigerant.

2. The refrigerating machine oil according to claim 1, comprising, as the oxygen-containing oil, an ester of a fatty acid and a polyhydric alcohol, wherein a ratio of C4 to C20 fatty acids in the fatty acid is from 20 to 100% by mole.

3. The refrigerating machine oil according to claim 1, wherein the 1-chloro-3,3,3-trifluoropropene refrigerant is a trans-1-chloro-3,3,3-trifluoropropene refrigerant.

4. A working fluid composition for a refrigerating machine comprising:
a refrigerating machine oil comprising as a base oil at least one oxygen-containing oil having a carbon/oxygen molar ratio of 2.5 or more and 5.8 or less, and
a 1-chloro-3,3,3-trifluoropropene refrigerant.

5. The working fluid composition for a refrigerating machine according to claim 4, wherein the refrigerating machine oil comprises, as the oxygen-containing oil, an ester of a fatty acid and a polyhydric alcohol, wherein a ratio of C4 to C20 fatty acids in the fatty acid is from 20 to 100% by mole.

6. The working fluid composition for a refrigerating machine according to claim 4, wherein the 1-chloro-3,3,3-trifluoropropene refrigerant is a trans-1-chloro-3,3,3-trifluoropropene refrigerant.

7.-8. (canceled)
